(19) United States
(12) Patent Application Publication
(10) Pub. No.: US 2015/0300262 A1
(43) Pub. Date: Oct. 22, 2015

(54) POWER GENERATION SYSTEM

(71) Applicant: MITSUBISHI HITACHI POWER SYSTEMS, LTD., Kanagawa (JP)

(72) Inventor: So MANABE, Tokyo (JP)

(73) Assignee: MITSUBISHI HITACHI POWER SYSTEMS, LTD., Kanagawa (JP)

(21) Appl. No.: 14/439,361

(22) PCT Filed: Nov. 26, 2013
(86) PCT No.: PCT/JP2013/081813

§ 371 Date: Apr. 29, 2015

(30) Foreign Application Priority Data
Jan. 21, 2013 (JP) 2013-008707

(51) Int. Cl. F02C 7/224; H01M 8/12; H01M 8/04; F02C 3/28; F02C 6/10

(52) U.S. Cl. CPC F02C 7/224; F02C 3/28; F02C 6/10; H01M 8/04111; H01M 8/04067; H01M 8/1246; F05D 2220/32; F05D 2260/20; H01M 2008/1293; H01M 2300/0074

(57) ABSTRACT

A power generation system provided with: a gas turbine (11) having a compressor (21) and a combustor (22); a SOFC (13); a first compressed air supply line (26) that supplies compressed air (A1) compressed by the compressor (21) to the combustor (22); a second compressed air supply line (31) that supplies a portion (A2) of the compressed air compressed by the compressor (22) to the SOFC (13); an exhaust air supply line (36) that supplies exhaust air (A3) discharged from the SOFC (13) to the combustor (22); a first fuel gas supply line (27) that supplies a fuel gas (L1) to the combustor (22); a second fuel gas supply line (41) that supplies a fuel gas (L2) to the SOFC (13); an exhaust fuel gas supply line (45) that supplies an exhaust fuel gas (L3) discharged from the SOFC (13) to the combustor (22); and a heat exchanger (61) serving as a heating device for heating the fuel gas (L1) supplied to the combustor (22) through the first fuel gas supply line (27).

### TECHNICAL FIELD

The present invention relates to a power generation system combining a fuel cell, a gas turbine, and a steam turbine, and to a method for starting a fuel cell in a power generation system.

### BACKGROUND ART

A solid oxide fuel cell (hereinafter, SOFC) as a fuel cell is known as a highly efficient fuel cell having wide use. Such an SOFC has a high operating temperature in order to increase ionic conductivity. Thus, compressed air that has been discharged from a compressor of a gas turbine is usable as the air supplied to an air electrode (as an oxidant). In addition, the SOFC enables exhausted high-temperature exhaust fuel gas to be used as fuel for a combustor of the gas turbine.

Thus, for example, as described in Patent Literature 1 listed below, various combinations of an SOFC, a gas turbine, and a steam turbine have been proposed as a power generation system that achieves high power generation efficiency. In the combined system disclosed in Patent Literature 1, the gas turbine has a compressor compressing air and supplying the compressed air to the SOFC and a combustor generating combustion gas from exhaust fuel gas exhausted from the SOFC and the compressed air.

### CITATION LIST

### Patent Literature

Patent Literature 1: Japanese Unexamined Patent Application Publication No. 2009-205930A

### SUMMARY OF THE INVENTION

### Technical Problem

As described above, in conventional power generation systems, the combustor generates combustion gas from the exhaust fuel gas exhausted from the SOFC and separately supplied fuel gas. In such a case, the exhaust fuel gas exhausted from the SOFC has a temperature of approximately 400° C. and the separately supplied fuel gas has a room temperature (for example, approximately 15° C.); thus, there is a large temperature difference between the two. Therefore, it is necessary to take thermal expansion measures for the piping and the like supplying the exhaust fuel gas or the fuel gas. In addition, there is a case where a mixer is provided in the piping upstream of the combustor in order to uniformly mix the exhaust fuel gas and the fuel gas. The provision of the mixer allows the low calorie exhaust fuel gas and the high calorie fuel gas to be mixed uniformly. However, since there is a large temperature difference between the exhaust fuel gas and the fuel gas, it is necessary to take thermal expansion measures for the mixer, its surrounding piping, such as piping supplying the exhaust fuel gas or the fuel gas to the mixer, and the like.

To solve the above described problem, an object of the present invention is to provide a power generation system in which thermal expansion measures for a mixer, its surrounding piping, and the like are unnecessary even when there is a large temperature difference between exhaust fuel gas and fuel gas.

### Solution to Problem

A power generation system of the present invention to achieve the object described above includes: a fuel cell; a gas turbine having a compressor and a combustor; a first compressed air supply line supplying compressed air from the compressor to the combustor; a second compressed air supply line supplying compressed air from the compressor to the fuel cell; an exhaust air supply line supplying exhaust air discharged from the fuel cell to the combustor; a first fuel gas supply line supplying first fuel gas to the combustor; a second fuel gas supply line supplying second fuel gas to the fuel cell; an exhaust fuel gas supply line supplying exhaust fuel gas discharged from the fuel cell to the combustor; and a heating device heating the first fuel gas supplied to the combustor through the first fuel gas supply line.

Accordingly, the first fuel gas is heated by the heating device when passing through the first fuel gas supply line, and the temperature difference between the exhaust fuel gas and the first fuel gas is reduced and the first fuel gas and the exhaust fuel gas, which have similar temperatures, are supplied to the combustor. Thus, the gas turbine combustor is able to efficiently combust the exhaust fuel gas and the first fuel gas at the same time to generate an optimum combustion gas, and it is possible to improve the power generation efficiency by securing stable combustion in the gas turbine combustor.

In the power generation system of the present invention, the heating device is a heat exchanger.

Accordingly, using a heat exchanger as the heating device, the heat is efficiently used, a separate combustor or the like is not required, and it is possible to suppress increases in cost.

In the power generation system of the present invention, the heat exchanger performs heat exchange between the exhaust air flowing in the exhaust air supply line and the first fuel gas flowing in the first fuel gas supply line.

Accordingly, the first fuel gas is heated by performing heat exchange between the exhaust air and the first fuel gas, and it is possible to efficiently heat the first fuel gas, to lower the temperature of the high-temperature exhaust air, and to reduce manufacturing costs by simplifying the supply equipment of the exhaust air.

In the power generation system of the present invention, the heat exchanger performs heat exchange between the exhaust fuel gas flowing in the exhaust fuel gas supply line and the first fuel gas flowing in the first fuel gas supply line.

Accordingly, the first fuel gas is heated by performing heat exchange between the exhaust fuel gas and the first fuel gas, and it is possible to efficiently heat the first fuel gas. It is also possible to reduce as much as possible the temperature difference between the exhaust fuel gas and the first fuel gas by lowering the temperature of the exhaust fuel gas.

In the power generation system of the present invention, the heating device has a first heat exchanger performing heat exchange between the exhaust air flowing in the exhaust air supply line and a heat exchange medium, and a second heat exchanger performing heat exchange between the heat exchange medium having undergone heat exchange in the first heat exchanger and the first fuel gas flowing in the first fuel gas supply line.

Accordingly, the first fuel gas is heated by receiving heat from the heat exchange medium heated by the exhaust air, and it is possible to secure the safety by preventing heat exchange between the fuel gases.

In the power generation system of the present invention, a mixer mixing the exhaust fuel gas flowing in the exhaust fuel gas supply line and the first fuel gas heated by the heating device is provided.

Accordingly, the exhaust fuel gas and the heated first fuel gas are mixed in the mixer and then supplied to the combustor, the temperature difference between the exhaust fuel gas and the first fuel gas is reduced, and it is possible to appropriately mix the two and to improve the combustion efficiency in the combustor.

### Advantageous Effect of Invention

According to the power generation system of the present invention, a heating device for heating the first fuel gas supplied to the combustor through the first fuel gas supply line is provided, and it is possible to efficiently combust the exhaust fuel gas and the first fuel gas to generate an optimum combustion gas, and to improve the power generation efficiency by securing stable combustion in the gas turbine combustor.

### BRIEF DESCRIPTION OF DRAWINGS

FIG. 1 is a schematic diagram illustrating a supply line of fuel gas in a power generation system according to Embodiment 1 of the present invention.

FIG. 2 is a schematic configuration diagram illustrating the power generation system according to Embodiment 1.

FIG. 3 is a schematic diagram illustrating a supply line of fuel gas in a power generation system according to Embodiment 2 of the present invention.

FIG. 4 is a schematic diagram illustrating a supply line of fuel gas in a power generation system according to Embodiment 3 of the present invention.

### DESCRIPTION OF EMBODIMENTS

Preferred embodiments of the power generation system according to the present invention will now be described in detail with reference to the attached drawings. Note that the present invention is not limited by these embodiments, and, when a plurality of embodiments are present, the present invention is intended to include a configuration combining these embodiments.

### Embodiment 1

The power generation system of Embodiment 1 is a Triple Combined Cycle (registered trademark) in which a solid oxide fuel cell (hereinafter, referred to as SOFC), a gas turbine, and a steam turbine are combined. This Triple Combined Cycle is able to generate power in the three stages of the SOFC, the gas turbine, and the steam turbine by disposing the SOFC on an upstream side of gas turbine combined cycle (GTCC) power generation, and is thus able to realize extremely high power generation efficiency. Note that the following description is made with a solid oxide fuel cell employed as the fuel cell of the present invention; however, no limitation to this type of fuel cell is intended.

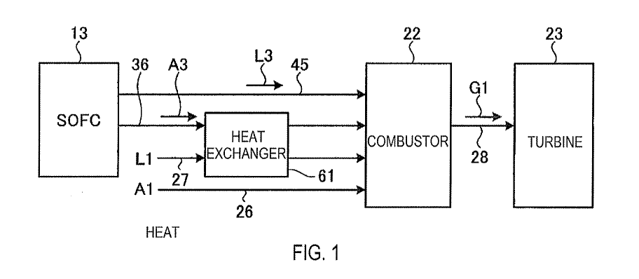

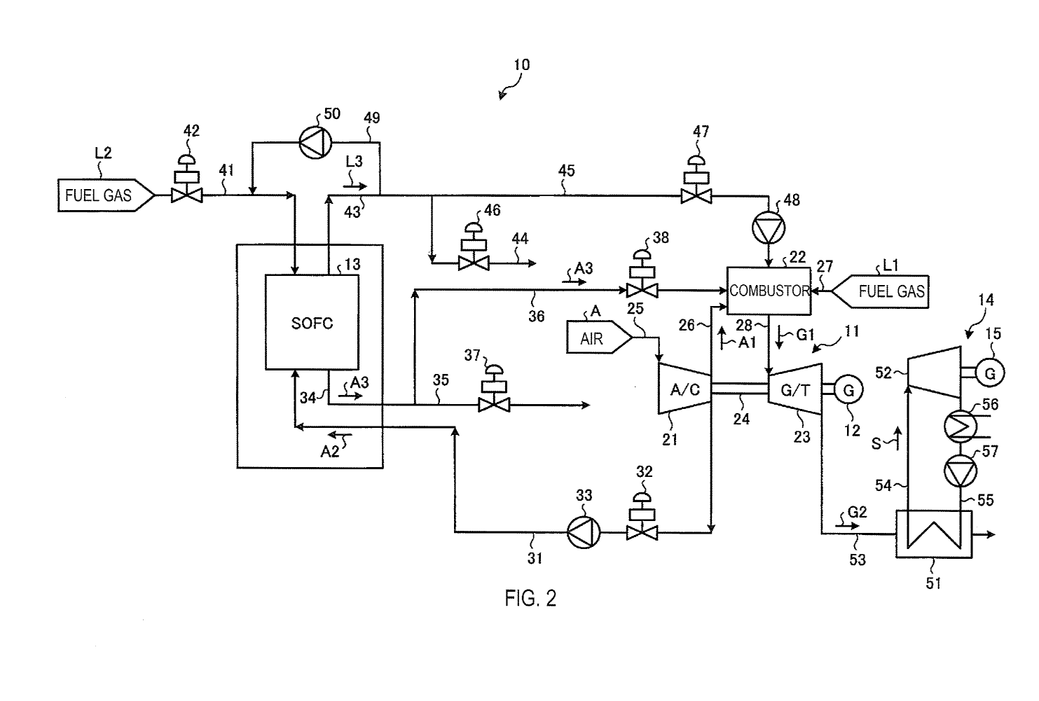

FIG. 1 is a schematic diagram illustrating a supply line of fuel gas in a power generation system according to Embodiment 1 of the present invention and FIG. 2 is a schematic configuration diagram illustrating the power generation system of Embodiment 1.

In Embodiment 1, as illustrated in FIG. 2, a power generation system 10 includes a gas turbine 11 and a power generator 12, an SOFC 13, and a steam turbine 14 and a power generator 15. The power generation system 10 combines power generation by the gas turbine 11, power generation by the SOFC 13, and power generation by the steam turbine 14, and is configured to achieve high power generation efficiency.

The gas turbine 11 includes a compressor 21, a combustor 22, and a turbine 23. The compressor 21 and the turbine 23 are coupled in an integrally rotatable manner by a rotating shaft 24. The compressor 21 compresses air A taken in through an air intake line 25. The combustor 22 mixes and combusts compressed air A1 supplied from the compressor 21 through a first compressed air supply line 26 and fuel gas L1 supplied from a first fuel gas supply line 27. The turbine 23 is rotated by combustion gas G1 supplied from the combustor 22 through an exhaust gas supply line 28. Although not illustrated, the turbine 23 is supplied with the compressed air A1 compressed by the compressor 21 through a casing, and cools blades and the like by using this compressed air A1 as cooling air. The power generator 12 is provided coaxially with the turbine 23 and is able to generate power as the turbine 23 rotates. Note that, for example, liquefied natural gas (LNG) is used as the fuel gas L1 to be supplied to the combustor 22.

The SOFC 13 is supplied with a high-temperature fuel gas as a reductant and with high-temperature air (oxidizing gas) as an oxidant, which react at a predetermined operating temperature to generate power. This SOFC 13 is constituted of an air electrode, a solid electrolyte, and a fuel electrode that are housed in a pressure container. A portion of compressed air A2, which has been compressed by the compressor 21, is supplied to the air electrode and fuel gas L2 is supplied to the fuel electrode, so that power is generated. Note that, here, as the fuel gas L2 supplied to the SOFC 13, for example, a liquefied natural gas (LNG), hydrogen (H₂) and carbon monoxide (CO), a hydrocarbon gas such as methane (CH₄), or gas manufactured in a gasification facility for carbonaceous materials such as coal is used. The oxidizing gas supplied to the SOFC 13 is a gas containing approximately 15% to 30% oxygen. Typically, air is suitable. However, in addition to air, mixed gas of combustion exhaust gas and air, mixed gas of oxygen and air, or the like can be used (hereinafter, the oxidizing gas supplied to the SOFC 13 is referred to as air).

This SOFC 13 is connected with a second compressed air supply line 31 that branches off from the first compressed air supply line 26, so as to be able to supply the portion of compressed air A2 compressed by the compressor 21 to an introduction part of the air electrode. This second compressed air supply line 31 is provided with a control valve 32 that is capable of adjusting the volume of air to be supplied, and a blower (booster) 33 that is capable of boosting the pressure of the compressed air A2, along the air-flow direction of the compressed air A2. The control valve 32 is provided on the upstream side in the flow direction of the compressed air A2 in the second compressed air supply line 31 and the blower 33 is provided on the downstream side of the control valve 32. The SOFC 13 is connected with an exhaust air line 34 discharging compressed air A3 (exhaust air) that has been used by the air electrode. This exhaust air line 34 branches into a discharge line 35 that discharges the compressed air A3 used by the air electrode to the outside, and a compressed air circulation line 36 that is connected to the combustor 22. The discharge line 35 is provided with a control valve 37 that is capable of adjusting the volume of air to be discharged. The compressed air circulation line 36 is provided with a control valve 38 that is capable of adjusting the volume of air to be circulated.

The SOFC 13 is also provided with a second fuel gas supply line 41 that supplies the fuel gas L2 to the introduction part of the fuel electrode. The second fuel gas supply line 41 is provided with a control valve 42 that is capable of adjusting the volume of fuel gas to be supplied. The SOFC 13 is connected with an exhaust fuel line 43 discharging exhaust fuel gas L3 that has been used by the fuel electrode. The exhaust fuel line 43 branches into a discharge line 44 that discharges the exhaust fuel gas L3 to the outside, and an exhaust fuel gas supply line 45 that is connected to the combustor 22. The discharge line 44 is provided with a control valve 46 that is capable of adjusting the volume of fuel gas to be discharged. The exhaust fuel gas supply line 45 is provided with a control valve 47 that is capable of adjusting the volume of fuel gas to be supplied, and with a blower 48 that is capable of boosting the pressure of the exhaust fuel gas L3, along the flow direction of the exhaust fuel gas L3. The control valve 47 is provided on the upstream side in the flow direction of the exhaust fuel gas L3 in the exhaust fuel gas supply line 45. The blower 48 is provided on the downstream side of the control valve 47.

The SOFC 13 is also provided with a fuel gas recirculation line 49 that connects the exhaust fuel line 43 and the second fuel gas supply line 41. The fuel gas recirculation line 49 is provided with a recirculation blower 50 that recirculates the exhaust fuel gas L3 from the exhaust fuel line 43 into the second fuel gas supply line 41.

The steam turbine 14 rotates a turbine 52 with steam generated by a heat recovery steam generator (HRSG) 51. The steam turbine 14 (turbine 52) is provided with a steam supply line 54 and a water supply line 55 between the turbine and the heat recovery steam generator 51. The water supply line 55 is provided with a condenser 56 and a water supply pump 57. This heat recovery steam generator 51 is connected with an exhaust gas line 53 from the gas turbine 11 (turbine 23), and generates steam S through heat exchange between high-temperature exhaust gas G2 supplied from the exhaust gas line 53 and water supplied from the water supply line 55. The power generator 15 is provided coaxially with the turbine 52 and is able to generate power as the turbine 52 rotates. Note that the exhaust gas G2 whose heat has been recovered by the heat recovery steam generator 51 is released into the atmosphere after removal of any toxic materials.

The operation of the power generation system 10 of Embodiment 1 is described next. When the power generation system 10 is started, the gas turbine 11, the steam turbine 14, and the SOFC 13 are started in the stated order.

First, in the gas turbine 11, the compressor 21 compresses the air A, the combustor 22 mixes the compressed air A1 with the fuel gas L1 and combusts the mixed gas, and the turbine 23 rotates due to the combustion gas G1. Thus, the power generator 12 begins to generate power. Next, in the steam turbine 14, the turbine 52 rotates due to the steam S generated by the heat recovery steam generator 51. Thus, the power generator 15 begins to generate power.

Subsequently, in order to start the SOFC 13, the compressed air A2 is supplied from the compressor 21 to the SOFC 13, so as to start pressurization and heating of the SOFC 13. The control valve 32 is opened to a predetermined lift while the control valve 37 of the discharge line 35 and the control valve 38 of the compressed air circulation line 36 are closed and the blower 33 of the second compressed air supply line 31 is stopped. Then, the portion of compressed air A2 compressed by the compressor 21 is supplied from the second compressed air supply line 31 toward the SOFC 13. Accordingly, the pressure is raised on the air electrode side of the SOFC 13 as the compressed air A2 is supplied thereto.

Meanwhile, on the fuel electrode side of the SOFC 13, the fuel gas L2 is supplied thereto to start raising the pressure. With the control valve 46 of the discharge line 44 and the control valve 47 of the exhaust fuel gas supply line 45 being closed and with the blower 48 being stopped, the control valve 42 of the second fuel gas supply line 41 is opened and the recirculation blower 50 of the fuel gas recirculation line 49 is driven. Then, the fuel gas L2 is supplied from the second fuel gas supply line 41 to the SOFC 13, and the exhaust fuel gas L3 is recirculated by the fuel gas recirculation line 49. Accordingly, the pressure is raised on the fuel electrode side of the SOFC 13 as the fuel gas L2 is supplied thereto.

Next, once the pressure on the air electrode side of the SOFC 13 reaches an outlet pressure of the compressor 21, the control valve 32 is fully opened and the blower 33 is driven. The control valve 37 is simultaneously opened and the compressed air A3 from the SOFC 13 is discharged from the discharge line 35. Then, the compressed air A2 is supplied toward the SOFC 13 by the blower 33. The control valve 46 is simultaneously opened and the exhaust fuel gas L3 from the SOFC 13 is discharged from the discharge line 44. Next, once the pressure on the air electrode side and the pressure on the fuel electrode side of the SOFC 13 reach a target pressure, the pressurization of the SOFC 13 ends.

Afterward, once the reaction (power generation) in the SOFC 13 stabilizes and the components of the compressed air A3 and the exhaust fuel gas L3 stabilize, the control valve 37 is closed while the control valve 38 is opened. Then, the compressed air A3 from the SOFC 13 is supplied to the combustor 22 through the compressed air circulation line 36. While the control valve 46 is closed, the control valve 47 is opened and the blower 48 is driven. Then, the exhaust fuel gas L3 from the SOFC 13 is supplied to the combustor 22 through the exhaust fuel gas supply line 45. At this point, the fuel gas L1 supplied to the combustor 22 through the first fuel gas supply line 27 is reduced.

Here, the power generation by the power generator 12 through the driving of the gas turbine 11, the power generation by the SOFC 13, and the power generation by the power generator 15 through the driving of the steam turbine 14 are all active, so that the power generation system 10 is in a steady operation state.

Here, in the gas turbine 11, the combustor 22 combusts a mixed gas of the exhaust fuel gas L3 discharged from the SOFC 13 and the fuel gas L1 supplied separately and sends the generated combustion gas to the turbine 23. In such a case, the exhaust fuel gas L3 discharged from the SOFC 13 has a temperature of approximately 400° C. and the fuel gas L1 has a room temperature (for example, approximately 15° C.), and there is a large temperature difference between the two. For this reason, it is difficult to sufficiently mix the high-temperature exhaust fuel gas L3 and the low-temperature fuel gas L1 in the combustor 22.

Therefore, in the power generation system 10 of Embodiment 1, as illustrated in FIG. 1, a heat exchanger 61 is provided as a heating device for heating the fuel gas (first fuel gas) L1 supplied to the combustor 22 through the first fuel gas supply line 27. The heat exchanger 61 performs heat exchange between the exhaust air A3 flowing in the exhaust air supply line 36 and the fuel gas L1 flowing in the first fuel gas supply line 27.

To explain in detail, to the combustor 22, the compressed air A1 compressed by the compressor 21 is supplied from a first air supply line 26, and the compressed air A3 exhausted from the SOFC 13 is supplied from the compressed air circulation line 36 via the heat exchanger 61. The compressed air A3 has a high temperature of approximately 600° C. Thus, the heat exchanger 61 performs heat exchange between the high-temperature compressed air A3 and the room-temperature fuel gas L1, and the heated fuel gas L1 is supplied to the combustor 22.

Accordingly, the fuel gas L1 reaches a temperature close to that of the exhaust fuel gas L3 by being heated by the compressed air A3, and the fuel gas L1 and the exhaust fuel gas L3 are appropriately mixed in the combustor 22. In addition, the compressed air A3 has its temperature lowered by heating the fuel gas L1, and the compressed air A1 and the compressed air A3 are appropriately mixed in the combustor 22. As a result, it is possible for the combustor 22 to efficiently mix and combust the fuel gas L1, the exhaust fuel gas L3, the compressed air A1, and the compressed air A3.

As such, the power generation system of Embodiment 1 is provided with: the gas turbine 11 having the compressor 21 and the combustor 22; the SOFC 13; the first compressed air supply line 26 supplying the compressed air A1 compressed by the compressor 21 to the combustor 22; the second compressed air supply line 31 supplying the portion of compressed air A2 compressed by the compressor 22 to the SOFC 13; the exhaust air supply line 36 supplying the exhaust air A3 discharged from the SOFC 13 to the combustor 22; the first fuel gas supply line 27 supplying the fuel gas L1 to the combustor 22; the second fuel gas supply line 41 supplying the fuel gas L2 to the SOFC 13; the exhaust fuel gas supply line 45 supplying the exhaust fuel gas L3 discharged from the SOFC 13 to the combustor 22; and the heat exchanger 61 serving as the heating device for heating the fuel gas L1 supplied through the first fuel gas supply line 27 to the combustor 22.

Accordingly, the fuel gas L1 is heated by the heat exchanger 61 when passing through the first fuel gas supply line 27, and the temperature difference between the exhaust fuel gas L3 and the fuel gas L1 is reduced and thermal expansion measures for the piping surrounding the combustor 22 are unnecessary. In addition, the combustor 22 is supplied with the fuel gas L1 and the exhaust fuel gas L3, which have similar temperatures, and it is possible to generate the combustion gas G1 by mixing and combusting the fuel gas L1 and the exhaust fuel gas L3 and to secure stable combustion in the combustor 22.

In such a case, the fuel gas L1 is heated by the heat exchanger 61; thus, the heat is efficiently used, a separate combustor is not required, and it is possible to suppress increases in cost.

In the power generation system of Embodiment 1, the heat exchanger 61 performs heat exchange between the compressed air A3 flowing in the exhaust air supply line 36 and the fuel gas L1 flowing in the first fuel gas supply line 27. Accordingly, the fuel gas L1 is heated by the compressed air A3, and it is possible to efficiently heat the fuel gas 11. In addition, it is possible to lower the temperature of the high-temperature compressed air A3 and it is not necessary to use a special material as the material of the supply equipment such as the piping used for the exhaust air supply line 36; thus it is possible to reduce manufacturing costs by simplifying the structure. Furthermore, the fuel temperature in the inlet portion in the combustor 22 is increased, the combustion efficiency is improved, and it is possible to improve the performance of the gas turbine 11.

In Embodiment 1 described above, description has been given of the heat exchanger 61 performing heat exchange between the compressed air A3 and the fuel gas L1; however, a configuration may be adopted where heat exchange is performed between the exhaust fuel gas L3 flowing in the exhaust fuel gas supply line 45 and the fuel gas L1.

### Embodiment 2

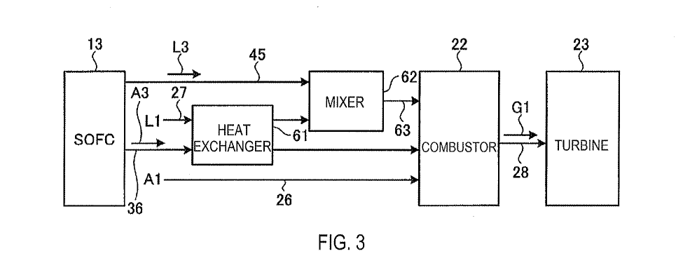

FIG. 3 is a schematic diagram illustrating a supply line of fuel gas in a power generation system according to Embodiment 2 of the present invention. Note that the same reference numerals are given to members having the same functions as the embodiment described above and detailed description thereof will be omitted.

In the power generation system of Embodiment 2, as illustrated in FIG. 3, in the same manner as Embodiment 1, there is provided a heat exchanger 61 as the heating device for heating fuel gas (first fuel gas) L1 supplied to a combustor 22 through a first fuel gas supply line 27. The heat exchanger 61 performs heat exchange between compressed air A3 flowing in an exhaust air supply line 36 and the fuel gas L1 flowing in the first fuel gas supply line 27. In addition, in the power generation system of Embodiment 2, there is provided a mixer 62 which mixes exhaust fuel gas L3 flowing in an exhaust fuel gas supply line 45 and the fuel gas L1 heated by the heat exchanger 61.

To explain in detail, to the combustor 22, compressed air A1 compressed by a compressor 21 is supplied from a first air supply line 26, and the compressed air A3 exhausted from an SOFC 13 is supplied from a compressed air circulation line 36 via the heat exchanger 61. As the compressed air A3 has a high temperature of approximately 600° C., the heat exchanger 61 performs heat exchange between the high-temperature compressed air A3 and the room-temperature fuel gas L1, and the heated fuel gas L1 is supplied to the mixer 62. After the mixer 62 mixes the heated fuel gas L1 and the exhaust fuel gas L3 from the exhaust fuel gas supply line 45, the mixed fuel gas is supplied from a mixed fuel gas supply line 63 to the combustor 22.

Accordingly, the fuel gas L1 has a temperature close to that of the exhaust fuel gas L3 by being heated by the compressed air A3, and the fuel gas L1 and the exhaust fuel gas L3 are appropriately mixed in the mixer 62. Then the mixed fuel gas is supplied to the combustor 22. In addition, the compressed air A3 has its temperature lowered by heating the fuel gas L1 and the compressed air A1 and the compressed air A3 are appropriately mixed in the combustor 22. As a result, it is possible for the combustor 22 to efficiently mix and combust the fuel gas L1, the exhaust fuel gas L3, the compressed air A1, and the compressed air A3.

As such, the power generation system of Embodiment 2 is provided with: the heat exchanger 61 as a heating device for heating the fuel gas L1 supplied through the first fuel gas supply line 27 to the combustor 22; and the mixer 62 which mixes the exhaust fuel gas L3 flowing in the exhaust fuel gas supply line 45 and the fuel gas L1 heated by the heat exchanger 61.

Accordingly, the fuel gas L1 is heated by the heat exchanger 61 when passing through the first fuel gas supply line 27, and the temperature difference between the exhaust fuel gas L3 and the fuel gas L1 is reduced and the fuel gas L1 and the exhaust fuel gas L3, which have similar temperatures, are supplied to the mixer 62. For this reason, thermal expansion measures for the mixer 62, the piping surrounding the mixer 62, and the like are unnecessary. In the mixer 62, the heated fuel gas L1 and the high-temperature exhaust fuel gas L3 are mixed and then supplied to the combustor 22, the temperature difference between the exhaust fuel gas L3 and the fuel gas L1 is reduced, and it is possible to appropriately mix the two. In the combustor 22, it is possible to generate the combustion gas G1 by combusting the mixed fuel gas of the fuel gas L1 and the exhaust fuel gas L3, and it is possible to improve the combustion efficiency by securing stable combustion in the combustor 22. In addition, it is possible to lower the temperature of the high-temperature compressed air A3 and it is not necessary to use a special material as the material of the supply equipment such as the piping used for this exhaust air supply line; thus it is possible to reduce manufacturing costs by simplifying the structure. Furthermore, the fuel temperature in the inlet portion in the combustor 22 is increased; thus the combustion efficiency is improved, and it is possible to improve the performance of the gas turbine 11.

In Embodiment 2 described above, description has been given of the heat exchanger 61 performing heat exchange between the compressed air A3 and the fuel gas L1; however, a configuration may be adopted where heat exchange is performed between the exhaust fuel gas L3 flowing in the exhaust fuel gas supply line 45 and the fuel gas L1.

### Embodiment 3

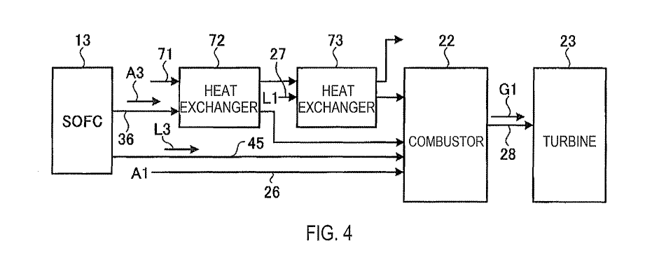

FIG. 4 is a schematic diagram illustrating a supply line of fuel gas in a power generation system according to Embodiment 3 the present invention. Note that the same reference numerals are given to members having the same functions as the embodiments described above and detailed description thereof will be omitted.

The power generation system of Embodiment 3, as illustrated in FIG. 4, is provided with a heat exchanger which performs heat exchange between compressed air A3 flowing in an exhaust air supply line 36 and fuel gas (first fuel gas) L1 flowing in a first fuel gas supply line 27 as a heating device for heating the fuel gas L1 supplied through the first fuel gas supply line 27 to a combustor 22. The heat exchanger has a first heat exchanger 72 performing heat exchange between the compressed air A3 flowing in the exhaust air supply line 36 and steam (heat exchange medium) flowing in a steam transporting line 71 and a second heat exchanger 73 performing heat exchange between the steam having undergone heat exchange in the first heat exchanger 72 and the fuel gas L1 flowing in the first fuel gas supply line 27. Note that, for the steam as the heat exchange medium, for example, steam generated by a heat recovery steam generator 51 may be used.

To explain in detail, the combustor 22 is supplied with compressed air A1 compressed by a compressor 21 from a first air supply line 26. The compressed air A3 exhausted from the SOFC 13 has a high temperature of approximately 600° C. and is supplied from the compressed air circulation line 36 to the heat exchanger 72. The exhaust fuel gas L3 exhausted from the SOFC 13 has a temperature of approximately 400° C. and is supplied from the exhaust fuel gas supply line 45 to the combustor 22. The first heat exchanger 72 heats the steam by performing heat exchange between the compressed air A3 flowing in the exhaust air supply line 36 and the steam flowing in the steam transporting line 71. Subsequently, the second heat exchanger 73 heats the fuel gas L1 by performing heat exchange between the heated steam and the fuel gas L1 flowing in the first fuel gas supply line 27. The compressed air A3, the temperature of which has been lowered in the heating, is supplied to the combustor 22 and the fuel gas L1, the temperature of which has been increased in the heating, is supplied to the combustor 22.

As such, the fuel gas L1 has its temperature increased by being heated by the compressed air A3 via the steam. Accordingly, the fuel gas L1 and the exhaust fuel gas L3 have similar temperatures and are appropriately mixed in the combustor 22. As a result, it is possible for the combustor 22 to efficiently mix and combust the fuel gas L1, the exhaust fuel gas L3, the compressed air A1, and the compressed air A3.

As such, the power generation system of Embodiment 3 is provided with the first heat exchanger 72 and the second heat exchanger 73 which perform heat exchange between the exhaust fuel gas L3 flowing in the exhaust fuel gas supply line 45 and the fuel gas L1 flowing in the first fuel gas supply line 27.

Accordingly, the fuel gas L1 is heated by the second heat exchanger 73 when passing through the first fuel gas supply line 27, and the temperature difference between the exhaust fuel gas L3 and the fuel gas L1 is reduced and thermal expansion measures for the piping surrounding the combustor 22 are unnecessary. In addition, the combustor 22 is supplied with the fuel gas L1 and the exhaust fuel gas L3, which have similar temperatures, and it is possible to generate the combustion gas G1 by efficiently combusting the fuel gas L1 and the exhaust fuel gas L3 at the same time and to secure stable combustion in the combustor 22.

In such a case, the fuel gas L1 is heated by the compressed air A3, and it is possible to efficiently heat the fuel gas L1 and to reduce the temperature difference between the exhaust fuel gas L3 and the fuel gas L1 as much as possible. In addition, the heat exchange lowers the temperature of the compressed air A3, and it is not necessary to use a special material as the material of the supply equipment such as the piping used for the exhaust air supply line 36; thus, it is possible to reduce manufacturing costs by simplifying the structure. Furthermore, the fuel temperature in the inlet portion in the combustor 22 is increased, the combustion efficiency is improved, and it is possible to improve the performance of the gas turbine 11.

The power generation system of Embodiment 3 is provided with the first heat exchanger 72 performing heat exchange between the exhaust fuel gas L3 flowing in the exhaust fuel gas supply line 45 and steam and the second heat exchanger 73 performing heat exchange between the steam having undergone heat exchange in the first heat exchanger 72 and the fuel gas L1 flowing in the first fuel gas supply line 27. Accordingly, the fuel gas L1 is heated by receiving heat from the steam heated by the exhaust fuel gas L3, and it is possible to secure the safety by preventing heat exchange between the fuel gases L1 and L3.

In Embodiment 3 described above, description has been given of the heat exchanger 72 performing heat exchange between the compressed air A3 and the fuel gas L1; however, a configuration may be adopted where heat exchange is performed between the exhaust fuel gas L3 flowing in the exhaust fuel gas supply line 45 and the steam. Note that, in Embodiment 3, in the same manner as Embodiment 2, a mixer which mixes the exhaust fuel gas L3 flowing in the exhaust fuel gas supply line 45 and the fuel gas L1 heated by the heat exchanger 61 may be provided.

In addition, in the embodiments described above, the heating device of the present invention is a heat exchanger; however, a heating device such as a combustor may be used.

### REFERENCE SIGNS LIST

10 Power generation system
11 Gas turbine
12 Power generator
13 Solid oxide fuel cell (SOFC)
14 Steam turbine
15 Power generator
21 Compressor
22 Combustor
23 Turbine
26 First compressed air supply line
27 First fuel gas supply line
31 Second compressed air supply line
32 Control valve (opening and closing valve)
33 Blower
34 Exhaust air line
36 Compressed air circulation line (exhaust air supply line)
41 Second fuel gas supply line
42 Control valve
43 Exhaust fuel line
45 Exhaust fuel gas supply line
49 Fuel gas recirculation line
61 Heat exchanger (heating device)
62 Mixer
63 Mixed fuel gas supply line
71 Steam transporting line
72 First heat exchanger (heating device)
73 Second heat exchanger (heating device)

1. A power generation system, comprising:
a fuel cell;
a gas turbine having a compressor and a combustor;
a first compressed air supply line supplying compressed air from the compressor to the combustor;
a second compressed air supply line supplying compressed air from the compressor to the fuel cell;
an exhaust air supply line supplying exhaust air discharged from the fuel cell to the combustor;
a first fuel gas supply line supplying first fuel gas to the combustor;
a second fuel gas supply line supplying second fuel gas to the fuel cell;
an exhaust fuel gas supply line supplying exhaust fuel gas discharged from the fuel cell to the combustor; and
a heating device heating the first fuel gas supplied to the combustor through the first fuel gas supply line.

2. The power generation system according to claim 1, wherein
the heating device is a heat exchanger.

3. The power generation system according to claim 2, wherein
the heat exchanger performs heat exchange between the exhaust air flowing in the exhaust air supply line and the first fuel gas flowing in the first fuel gas supply line.

4. The power generation system according to claim 2, wherein
the heat exchanger performs heat exchange between the exhaust fuel gas flowing in the exhaust fuel gas supply line and the first fuel gas flowing in the first fuel gas supply line.

5. The power generation system according to claim 1, wherein
the heating device has a first heat exchanger performing heat exchange between the exhaust air flowing in the exhaust air supply line and a heat exchange medium, and a second heat exchanger performing heat exchange between the heat exchange medium having undergone heat exchange in the first heat exchanger and the first fuel gas flowing in the first fuel gas supply line.

6. The power generation system according to claim 1, further comprising a mixer mixing the exhaust fuel gas flowing in the exhaust fuel gas supply line and the first fuel gas heated by the heating device.
